(19) United States
(12) Patent Application Publication
(10) Pub. No.: US 2001/0034695 A1
(43) Pub. Date: Oct. 25, 2001

(54) Intellectual property financial markets method and system

(76) Inventor: William T. Wilkinson, Salem, NJ (US)

Correspondence Address: Ratner & Prestia, P.O. Box 7228, Wilmington, DE, 19803, US

(21) Appl. No.: 09/797,930

(22) Filed: Mar. 2, 2001

Related U.S. Application Data
(60) Provisional application No. 60/186,547, filed on Mar. 2, 2000.

(51) Int. Cl. G06F 17/60

(52) U.S. Cl. 705/37

(57) ABSTRACT

A method and system for facilitating tangible valuation of intellectual property assets. The method comprises providing a centralized intellectual property market accessible to others in which one or more financial instruments, each instrument representing an interest in at least one intellectual property asset, may be exchanged in one or more transactions for a tangible value. The market may comprise means for accepting bids from one or more first parties interested in acquiring one or more financial instruments, means for accepting asking positions from one or more second parties interested in receiving value in exchange for the one or more financial instruments, and means for matching the bids and asking positions and facilitating transactions between the first and second parties. The market enables methods for acquiring and selling shares in intellectual property assets, for computing the value of business entities by taking into account the value of intellectual property assets owned by the entities, and for creating mutual funds based upon shares in intellectual property assets.

### CROSS-REFERENCE TO RELATED APPLICATIONS

This application claims priority of U.S. Provisional Application Ser. No. 60/186,547, filed on Mar. 2, 2000, incorporated herein by reference.

### TECHNICAL FIELD

This invention relates to intellectual property, and more particularly to a financial market for intellectual property.

### BACKGROUND OF THE INVENTION

Increasingly, Intellectual Property (IP) assets are becoming more important and valuable to business. They are unique assets that have heretofore been classified as intangible, but are now being recognized as having a more tangible or real value. A number of IP valuation methods are known in the art, such as methods disclosed in U.S. patent application Ser. No. 09/593,576, titled “INTELLECTUAL PROPERTY VALUATION PROCESS,” filed Jun. 14, 2000 (claiming priority on a provisional application filed Jun. 14, 1999), by the common inventor of this invention, and incorporated herein by reference. Heretofore, however, there has been no central marketplace for IP and related assets.

### SUMMARY OF THE INVENTION

In accordance with this invention, there is provided a method for facilitating tangible valuation of intellectual property assets. The method comprises providing a centralized intellectual property market accessible to others in which one or more financial instruments may be exchanged in one or more transactions for a tangible value. Each instrument represents an interest in at least one intellectual property asset, including but not limited to patents, trademarks, copyrights, domain names, databases, trade secrets, and licenses in any of the above. The financial instrument may any of the types of instrument known in business, including but not limited to debt, equity, options, derivatives, and convertibles. The transaction may comprise any transaction mechanism known in the art, including buying, selling, bartering, trading, hypothecating, optioning, and donating. The tangible value may comprise fair market value, collateral value, liquidation value, tax value, appraisal value, charitable donation value, or any type of value desired in an asset. One or more sub-markets within the centralized intellectual property market may also be provided, each sub-market for exchanging a particular type of intellectual property asset, exchanging a particular type of financial instrument, exchanging a particular type of tangible value, utlilizing a particular type of transaction mechanism, exchanging instruments representative of assets related to a particular industry or field of business, or a combination thereof.

The method may further comprise, for one or more intellectual property assets: determining a classification for the IP asset (patent, trademark, etc.) and the type of value desired for the IP asset; gathering valuation data on the intellectual property asset; computing a value for the intellectual property asset, taking into account the valuation data; auditing the value of the intellectual property asset; determining the type of financial instrument, type of value, and type of transaction mechanism to be used for listing the intellectual property asset in the centralized intellectual property market; determining the number of shares and computing a value per share of the intellectual property asset to be offered on the market; and making the shares available for exchange on the market.

The invention also comprises a system for facilitating tangible valuation of intellectual property assets. The system comprises a centralized intellectual property market accessible to others in which one or more financial instruments, each instrument representing an interest in at least one intellectual property asset, may be exchanged in one or more transactions for a tangible value. The market comprises means for accepting bids from one or more first parties interested in acquiring one or more financial instruments, each financial instrument representing an interest in one or more selected intellectual property assets; means for accepting asking positions from one or more second parties interested in receiving value in exchange for the one or more financial instruments; and means for matching the bids from one or more first parties to the asking positions of the one or more second parties and facilitating one or more transactions between the first and second parties. The means for accepting and matching the bids and asking positions may comprise a computer having computer readable program code means embodied therein for causing the accepting and matching. The computer may be accessible by any known means, including but not limited to a global computer information network, a local computer network, telephone, or a combination thereof.

The invention also comprises a method for acquiring at least one financial instrument representing an interest in at least one intellectual property asset, the method comprising accessing a centralized intellectual property market, placing a bid for the at least one financial instrument, and acquiring the at least one financial instrument in exchange for value. Similarly, a method for exchanging at least one financial instrument representing an interest in at least one intellectual property asset may comprise accessing a centralized intellectual property market, communicating an asking position for the at least one financial instrument, and exchanging the at least one financial instrument for value. The bid may be placed or asking position may be communicated with a restriction on a maximum or minimum acceptable amount of value for the at least one financial instrument.

The market may be used for establishing a tangible value for at least a portion of an intellectual property asset, the method comprising offering one or more of financial instruments representative of an interest in the portion of the intellectual property asset for exchange on the centralized intellectual property market and computing the tangible value of the portion of the intellectual property asset by multiplying the number of units of the financial instrument by the value per unit. The value of a business entity may be computed by taking into account an intellectual property exchange value of one or more intellectual property assets owned by the business entity, each asset having at least one financial instrument representing an interest therein listed on the centralized intellectual property market, where the intellectual property exchange value is computed by multiplying the number of units of the financial instrument by the tangible value per unit. The intellectual property exchange value may then be used as a basis for any financial transaction.

The market also provides a method for enabling investment in one or more intellectual property assets, the method comprising creating a mutual fund comprising one or more financial instruments each representing an interest in one or more intellectual property assets, the financial instruments offered for exchange on the centralized intellectual property market.

### BRIEF DESCRIPTION OF DRAWINGS

FIG. 1 is a flowchart of an exemplary method for entering the IP market of the present invention.

FIG. 2 is a flowchart of an exemplary method for valuation of an entity in accordance with the present invention.

### DETAILED DESCRIPTION OF INVENTION

The invention comprises a centralized intellectual property market accessible to others in which one or more financial instruments representing an interest in one or more intellectual property assets may be exchanged for tangible value by any type of transactional mechanism. The intellectual property assets offered for exchange may include but are not limited to: patents (including utility, design, or plant, with a status of pending, allowed, or issued), trademarks (including service marks, word marks, design marks and logos, trade dress, and the like), domain names, copyrights, trade secrets, and databases, as well as licenses in any of the above. The financial instrument may comprise any of the instruments known in business that convey any representative interest or share in an asset, including but not limited to debt, equity, option, derivative, and convertible instruments. The term “share” and “financial instrument” are used herein synonymously to mean any such tradable security or representative interest in an asset, including an interest in the entire asset. The transactional mechanism may comprise any transaction mechanism known in the art, including but not limited to buying, selling, bartering, trading, hypothecating, optioning, and donating. The tangible value may comprise any type of value desired, including but not limited to fair market value, collateral value, liquidation value, tax value, appraisal value, charitable donation value, and the like.

The IP market thus creates a marketplace for heretofore intangible assets, giving them tangible monetary values and creating liquidity, thus treating IP as a tangible asset. The market may further be subdivided into one or more sub-markets, each sub-market for exchanging a particular type of intellectual property asset, exchanging a particular type of financial instrument, exchanging a particular type of tangible value, utlilizing a particular type of transaction mechanism, exchanging financial instruments representative of interests in IP assets related to a particular industry or field of business, or a combination thereof, in accordance with the various types of assets, instruments, value, and transaction mechanisms noted above.

The centralized IP market may be accessible in person or via any electronic or non-electronic communication mechanism, including but not limited to global computer networks (such as the Internet) or local computer networks, telephone, facsimile, mail, and the like. Access to the global or local computer networks may be gained by any user interface, such as computers (including terminals, personal computers, laptops, handheld portable desk assistants (PDAs), and the like), telephone (including cellular, satellite, ground-based, and the like), interactive television, and any other means known in the art. Transmissions to the global or local computer networks may be received via ground lines or by electromagnetic waves of any frequency, such as but not limited to the frequencies used by radio, cellular phone, and satellites.

Preferably, the market includes a physical location, with a trading floor, and a computerized, remotely-accessible marketplace, and telephones. The market may generally comprise means for accepting bids from one or more first parties interested in acquiring one or more financial instruments, each financial instrument representing an interest in one or more selected intellectual property assets; means for accepting asking positions from one or more second parties interested in receiving value in exchange for the one or more financial instruments; and means for matching the bids from one or more first parties to the asking positions of the one or more second parties and facilitating one or more transactions between the first and second parties.

The means for accepting and matching the bids and asking positions may comprise a computer having computer readable program code means (such as in software, firmware, or hardware) embodied therein for causing the accepting and matching. For example, the number of shares for exchange and asking position posted by a first party may be entered in the computer with an identifier of the IP asset and type of financial instrument for which the shares are related and a bid may be posted by second party with the same identifiers. The computer matches the identifiers for the asset and instrument, and then determines whether there are any minimum or maximum value restrictions on the match. If the restrictions are satisfied for both parties, the computer may complete the transaction. If the restrictions are not satisfied for one or the other of the parties, the computer may reject that match and continue to seek matches for both parties until a satisfactory match is made.

The means may instead, however, be manual and may comprise specialists (people) personally making contacts and making records to facilitate the transactions in person, by telephone, mail, fax, and the like. The specialist in a manual system performs the same functions as the computer in a computerized system. Other known means for making business transactions may also be employed.

The market may further include means for periodically providing notice of the market value of the financial instruments. The means for providing notice comprise any means of communication known in the art, and preferably any means typically used for communicating market values for financial instruments as are known in the art, including tickertape, newspaper, computer, television, monitor, illuminated sign, audible announcement, and the like.

The IP exchange may benefit from the services of analysts, specialists, and market-makers who may make the determinations in each of the sub-markets. Dealers and market-makers may specialize in certain categories of intellectual property or business types. The exchange may further use the services of specialists, dealers and market makers experienced in different types of financial transactions and financial securities based upon the value of intellectual property assets.

The exchange may use an open market auction process that can be used to establish the fair market values of intellectual property assets, or shares in one or more intellectual property assets, through a bid/ask process. The bid/ask process may comprise a first party offering an intellectual property asset or representative financial instrument for exchange, at the market value, or with a restriction, such as a minimum acceptable value. A second party may then offer to acquire the intellectual property asset or representative financial instrument at the market value, or with a restriction, such as a maximum acceptable value.

To facilitate trade and mutual or joint ownership of particular assets or licensed technology, the market process includes the creation of financial instruments or shares comprising representative interests in an intellectual property asset, and may further include the creation of one or more mutual funds composed of financial instruments based upon intellectual property assets. The exchange may also include a market for the licensing and trading of licenses for intellectual property assets, using a determination of the value of the intellectual property assets covered by each license.

Also to facilitate trade, a master index file on intellectual property assets listed on the exchange may be created. For each listed asset, the index file may include any or all of the following data without limitation (where applicable): type of asset, value of asset, type of financial instrument, type of value sought, type of transaction sought, industry or field of business, asset/product description, inventor(s), filing date, allowance date, issue date, assignee/owner, patent/trademark/copyright number, licensees, country, status (pending, issued, lapsed, expired), and the like.

The IP market may be regulated or supervised by a corresponding federal agency, such as the Securities and Exchange Commission (SEC), much in the same way that the SEC regulates the trading of stocks. The SEC or other analogous body may require registration of the financial instruments with that body before the instruments can be listed on the exchange, may enforce a set of rules for regulating the market and the people qualified to conduct business on the exchange, and may assess fees or taxes, such as transaction fees or listing fees, to fund the regulatory process.

The IP market of this invention provides an independent valuation/appraisal method and service that periodically calculates and tracks the desired value of a particular intellectual property asset, much in the same way that stock markets set the market capitalization of corporations. The term “IP exchange value” as used herein refers to the value of a particular intellectual property asset or group of assets as determined by the market forces of the IP market, and refers to whatever value (such as fair market value, collateral value, and the like as noted elsewhere herein) that is the subject of the particular market on which the financial instruments representative of the financial interest in the assets are listed. The IP exchange value for a particular asset may be computed as the value of a single unit of a financial instrument representative of an interest in the asset multiplied by the number of units of the financial instrument issued. For example, where the financial unit is a share of equity (a stock), the value is the number of shares multiplied by the share price. Where only a portion of an asset is represented by issued financial instruments, the value of the entire asset is proportional to the value of the portion of the asset as valued via the IP market. The IP market automatically takes into account changing economic/political factors and/or changes in currency values of the country or countries in which the IP asset is enforceable. Use of the IP market further enables the adjustment and revaluation of the assets and balance sheets of business organizations, to account for the tangible values of intellectual property assets, as set by the market.

Thus, the valuation method of using IP market may comprise computing the value in part or in whole of any business entity for any purpose by taking into account the tangible market value of IP assets. A business entity may be any business organization or part thereof, such as a partnership, fund, corporation, trust, foundation, endowment, sole proprietorship, association, and the like. The purpose of determining the value may include for use as a basis for any financial transaction or for any business or financial purpose, including, for taxation, preparation of financial statements, debt/equity transactions, purchases, sales, loans, collateral, donations, exchanges, investing, trading, mergers, acquisitions, spin-offs, liquidation, buybacks, leveraged buyouts, stock/debt exchanges, hedge funds, and the like. The IP exchange value may also be used to determine the value of organizations with business assets for the purpose of reorganization, refinancing, liquidation, and the like during bankruptcy proceedings.

IP exchange values may be used to determine the value of a research and development project for a particular technology or product, or the value of patents, licenses, and the like that result from such research and development. The IP exchange value may be used to determine the value of business plans and capital funding requests, and business enterprises, for use in obtaining any type of financing, such as debt, equity, charitable, and the like, through any type of financial institution or mechanism, including but not limited to banks, venture capitalists, and investment bankers. The IP exchange value may also be used for determining values for underwriting debt or equity security issues, for public or private offerings, including initial public offerings (IPOs). IP exchange values may further be used for determining insurance and insurance underwriting risk, and in the creation of insurance risk pools.

IP exchange values may be used to establish security values or prices, for the purpose of investing, such as in shares, units, options, derivatives, mutual funds, partnerships, futures, and the like. The rating of debt, bonds, or adjusting the debt risk/credit ratings of securities or business organizations, may take into account the IP exchange value. The price of debt issues may be set or adjusted by taking into account the IP exchange value along with the credit rating of the debt issuer. A security (debt or equity) risk rating service may be based at least in part upon the IP exchange value and may be used to rate individual securities. The IP exchange value may further be used to determine the value of security indexes.

Related Accounting Methods and Processes

The use of the IP market further creates a need for unique accounting methods and processes as part of the overall process in establishing tangible values for intellectual property assets. Accordingly, part of the valuation and market process for intellectual property assets preferably includes an independent audit, and opinion, attesting to the value of an intellectual property asset, preferably by a certified public accounting (CPA) firm, who confirms and verifies the accuracy of the computed value, and renders an independent opinion that the value are fairly stated.

Such an independent auditor typically audits the IP assets and their underlying valuation factors by first compiling data on all the relevant valuation factors of the IP asset. Then, a tangible asset value for the IP asset is computed based on all the compiled relevant valuation data. The tangible value of an intellectual property asset is then recorded by debiting the appropriate asset account on the balance sheet and crediting the equity/capital account. The value of an IP asset may be depreciated based upon certain factors, such as a patent life (time remaining until expiration), term of licenses, competitive substitutes, and the like.

Comprehensive Process

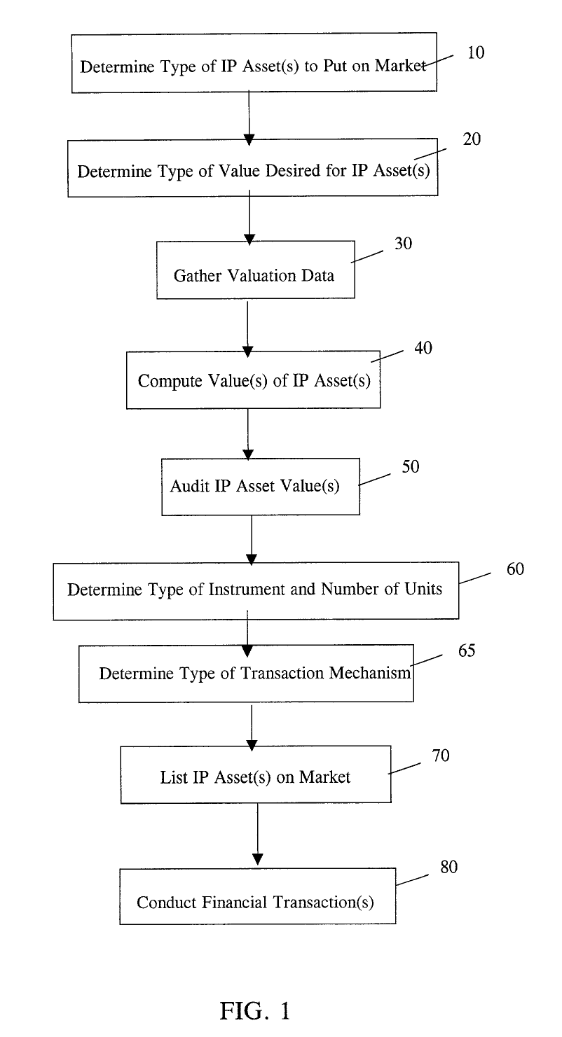

Referring now to FIG. 1, there is shown a flow diagram for an exemplary comprehensive process for using the IP market of this invention for establishing a tangible value for an intellectual property asset (IPA). As shown in FIG. 1, first the type of asset (patent, trademark, copyright, etc.) and type of value (fair market, collateral, etc.) desired are determined, as shown in steps 10 and 20, respectively. Next, valuation data is gathered on the IPA in step 30, and the value of the IPA is computed in step 40. A valuation service may be employed to make this determination. Then, the IPA value is audited in step 50, preferably by a CPA firm that conducts an independent audit and provides an opinion stating that the value is fairly stated. Next, in step 60, the type of financial instrument and number of financial instruments to be issued is determined, and in step 65, the type of transaction mechanism desired is also determined. In step 70, the financial instruments are listed on the appropriate market or sub-market for the asset type, valuation type, financial instrument type, desired transaction mechanism, and/or industry or field of business of the asset. Then, transactions of the financial instruments take place in step 80.

The transactions may comprise, for example, a buyer placing a purchase order, a seller places a sell order, a specialist or computer recording the buy and sell orders, and the computer or specialist then matching the buy and sell orders in and facilitating completion of the transaction, thus establishing the tangible value for the IPA. Although expressed above with respect to buying and selling, the transaction may involve any transaction mechanism known in the art, including but not limited to any of those discussed above.

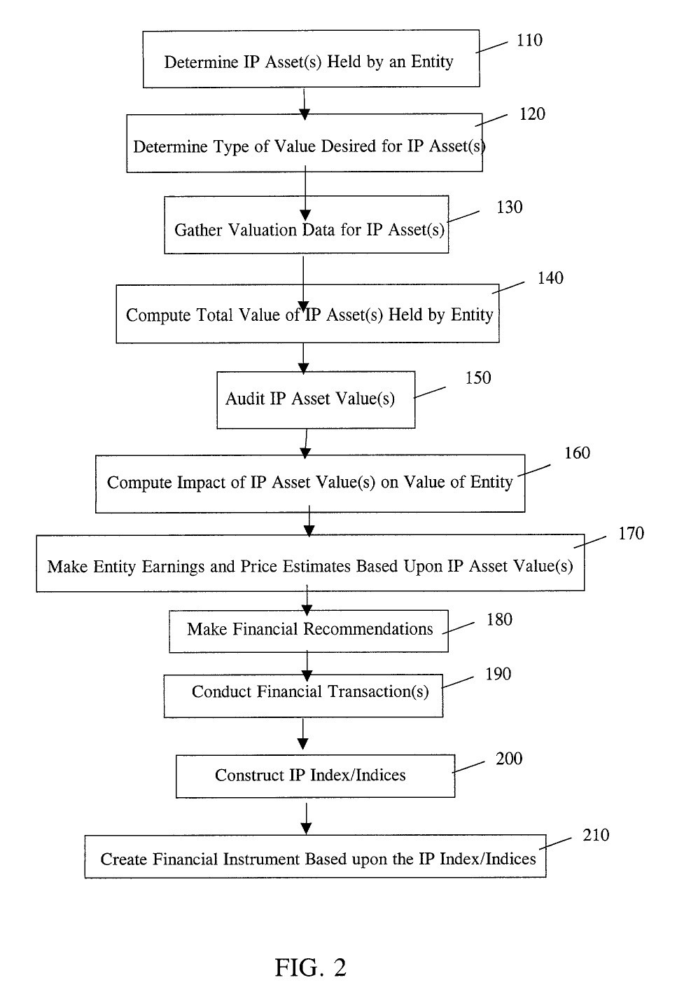

Referring now to FIG. 2, there is shown an exemplary flowchart for a method for valuation of an entity based upon its intellectual property assets. The valuation method comprises in step 110, determining the IP asset(s) held by an entity. Next, in step 120, the type of value desired for the asset(s) is/are determined, such as any of the types of value discussed herein. Then, in step 130, valuation data for the IP asset(s) is gathered and the total value of the IP asset(s) held by entity is computed, as indicated in step 140. The IPA value(s) are then audited in step 150, preferably by a CPA firm that conducts an independent audit and provides an opinion stating that the IP asset value(s) is/are fairly stated. Then, the impact of IP asset value(s) on earnings and on the price/security values of entity is computed, as indicated in step 160. Once this impact has been computed, entity earnings and price estimates are made in step 170 based upon the IP asset value(s). These estimates may involve adjusting traditional or existing published security earnings/price estimates to reflect the impact of the IP valuations on the entity. Then, in step 180, financial recommendations may be made, such as but not limited to (1) security recommendations such as buy, sell, hold (2) new issue debt or equity pricing recommendations such as for IPOs and secondary offerings or (3) pricing recommendations for mergers & acquisitions, buyouts (including LBOs), spinoffs, or bankruptcy. In step 190, the method then comprises conducting financial transactions based upon the recommendations and valuation information based upon the IP asset value(s).

The method of this invention may further comprise, as indicated by step 200 in FIG. 2, constructing (gathering data and computing) an IP index or indices composed of individual IP assets, IP-impacted securities, or entities holding IP assets for the purpose of investment, comparison, and performance evaluation purposes. In this way, financial instruments related to IP assets or entities holding IP assets may be tracked against the performance of other IP assets or entities holding IP assets. The index may be used as a basis to compare investments, select investments, or a combination thereof.

Once such an IP index or indices exist(s), an index-mimicking financial instrument, such as but not limited to a security or fund, based upon the IP index/indices, may be created, so that others may invest in that financial instrument. The index-mimicking fund may comprise appropriately weighted shares in all of the financial instruments that comprise the index, or may merely approximate the index by comprising a combination and weighting of only a portion of the financial instruments in such a way that the performance of the fund tracks the market movement of the index. Such an instrument may seek to match the performance of the IP index much in the same way that various index funds are devised to match the performance of certain segments of the stock market, or the market as a whole.

Although steps 200 and 210 are appended to the bottom of FIG. , it should be understood that the index or indices created in accordance with this invention may be devised by a different party than the party conducting steps 110-190. Likewise it should be recognized that although a first party, such as an analyst, may perform steps 110-180, anyone may perform step 190 based upon that analyst's recommendations. It should be further understood that the formation of an index and corresponding index fund may be in relation to any existing market, taking into account data generated via the IP market of this invention, but may also be generated specifically to track performance of the financial instruments listed on the IP market of this invention.

It should be understood that to the extent that specific examples of assets, financial instruments, transaction mechanisms, tangible value types, and valuation purposes are described above, the system and method is by no means limited to these detailed examples. Those skilled in the art having the benefit of the teachings of the present invention as set forth herein above, can effect numerous modifications thereto. These modifications are to be construed as being encompassed within the scope of the present invention as set forth in the appended claims.

What is claimed:

1. A method for facilitating tangible valuation of intellectual property assets, the method comprising:
(a) providing a centralized intellectual property market accessible to others in which one or more financial instruments, each instrument representing an interest in at least one intellectual property asset, may be exchanged in one or more transactions for a tangible value.

2. The method of claim 1 wherein the intellectual property asset comprises an asset selected from the group consisting of: patents, trademarks, copyrights, domain names, databases, trade secrets, and licenses therefor.

3. The method of claim 1 wherein the financial instrument comprises an instrument selected from the group consisting of: debt, equity, options, derivatives, and convertibles.

4. The method of claim 1 wherein the transaction comprises a mechanism selected from the group consisting of: buying, selling, bartering, trading, hypothecating, optioning, and donating.

5. The method of claim 1 wherein the tangible value is a value selected from the group consisting of: fair market value, collateral value, liquidation value, tax value, appraisal value, or charitable donation value.

6. The method of claim 1 further comprising:
(b) accepting a bid from at least a first party who is interested in acquiring at least one first financial instrument representing an interest in a first intellectual property asset;
(c) accepting an asking position from at least a second party who is interested in receiving value in exchange for one of the first financial instruments;
(d) matching the bid to the asking position and facilitating a transaction involving the first financial instrument between the first party and the second party.

7. The method of claim 1 further comprising providing one or more sub-markets within the centralized intellectual property market, each sub-market for exchanging a particular type of intellectual property asset, exchanging a particular type of financial instrument, exchanging a particular type of tangible value, utlilizing a particular type of transaction mechanism, exchanging instruments representative of assets related to a particular industry or field of business, or a combination thereof.

8. The method of claim 7 wherein the particular type of intellectual property assets is selected from the group consisting of: patents, trademarks, copyrights, domain names, databases, and trade secrets.

9. The method of claim 7 wherein the particular type of financial instrument is selected from the group consisting of: debt, equity, options, derivatives, and convertibles.

10. The method of claim 7 wherein the particular type of tangible value is a value selected from the group consisting of: fair market value, collateral value, liquidation value, tax value, appraisal value, or charitable donation value.

11. The method of claim 7 wherein the particular type of transaction mechanism comprises a mechanism selected from the group consisting of: buying, selling, bartering, trading, hypothecating, optioning, and donating.

12. The method of claim 7 wherein the particular type of tangible value is a value selected from the group consisting of: fair market value, collateral value, liquidation value, tax value, appraisal value, or charitable donation value.

13. The method of claim 1 further comprising, for one or more intellectual property assets:
(b) determining a classification for the intellectual property asset and a type of value desired for the asset;
(c) gathering valuation data on the intellectual property asset;
(d) computing a value for the intellectual property asset taking into account the valuation data;
(e) auditing the value of the intellectual property asset;
(f) determining the type of financial instrument and type of transaction mechanism to be used for listing the intellectual property asset in the centralized intellectual property market;
(g) determining the number of shares and computing a value per share of the intellectual property asset to be offered on the market, and
(h) making the shares available for exchange on the market.

14. A system for facilitating tangible valuation of intellectual property assets, the system comprising a centralized intellectual property market accessible to others in which one or more financial instruments each representing an interest in at least one intellectual property asset may be exchanged in one or more transactions for a tangible value, the market comprising:
means for accepting bids from one or more first parties interested in acquiring one or more financial instruments, each financial instrument representing an interest in one or more selected intellectual property assets;
means for accepting asking positions from one or more second parties interested in receiving value in exchange for the one or more financial instruments; and
means for matching the bids from one or more first parties to the asking positions of the one or more second parties and facilitating one or more transactions between the first and second parties.

15. The system of claim 14 wherein the means for accepting and matching the bids and asking positions comprises a computer having computer readable program code means embodied therein for causing the accepting and matching.

16. The system of claim 15 wherein the computer is accessible via a global computer information network, a local computer network, telephone, or a combination thereof.

17. The system of claim 14 further comprising means for communicating market values for the financial instruments exchanged via the market.

18. The system of claim 17 wherein the means for communicating the market values comprises a communication method selected from the group consisting of: tickertapes, newspapers, computers, television broadcasts, closed-circuit monitors, illuminated signs, and audible announcements.

19. A method for acquiring at least one financial instrument representing an interest in at least one intellectual property asset, the method comprising accessing a centralized intellectual property market, placing a bid for the at least one financial instrument, and acquiring the at least one financial instrument in exchange for value.

20. The method of claim 19 further comprising placing the bid with a restriction on a maximum amount of value to be exchanged for the at least one financial instrument.

21. A method for exchanging at least one financial instrument representing an interest in at least one intellectual property asset, the method comprising accessing a centralized intellectual property market, communicating an asking position for the at least one financial instrument, and exchanging the at least one financial instrument for value.

22. The method of claim 21 further comprising communicating the asking position with a restriction on a minimum amount of value to be accepted for the at least one financial instrument.

23. A method for establishing a tangible value for at least a portion of an intellectual property asset, the method comprising:
(a) offering one or more of shares in the portion of the intellectual property asset for exchange on a centralized intellectual property market in which shares in a plurality of intellectual property assets may be exchanged for value;
(b) computing the tangible value of the portion of the intellectual property asset by multiplying the number of shares by the value per share.

24. A method for computing a value of a business entity, the method comprising taking into account an intellectual property exchange value of one or more intellectual property assets owned by the business entity, each asset having at least one financial instrument representing an interest therein listed on a centralized intellectual property market in which the financial instruments may be exchanged for tangible value by any transaction mechanism, the intellectual property exchange value computed by multiplying the number of shares by the tangible value per share.

25. The method of claim 24 further comprising using intellectual property exchange value as a basis for a financial transaction.

26. The method of claim 25 wherein the financial transaction comprises a transaction selected from the group consisting of: securing financing; underwriting a security; establishing a securing value for an investment; conducting a merger, acquisition, spin-off, buyback, or leveraged buyout; making a stock/debt exchange; establishing a hedge fund; reorganizing, refinancing, or liquidating the business entity under bankruptcy; determining insurance or underwriting risk; and creation of an insurance risk pool.

27. The method of claim 24 further comprising using intellectual property exchange value in rating the business entity, or rating debt or credit issued by the business entity.

28. A method for enabling investment in one or more intellectual property assets, the method comprising creating a mutual fund comprising one or more financial instruments each representing an interest in one or more intellectual property assets, the financial instruments offered for exchange on a centralized intellectual property market wherein the financial instruments may be exchanged for tangible value by any transaction mechanism.

29. The method of claim 1 further comprising an overseeing body regulating the intellectual property market by requiring registration of the financial instruments with the body before the financial instruments can be listed on the market, enforcing a set of rules regarding practices and policies used by the market and persons qualified to conduct business on the market, and optionally, assessing fees to fund the regulatory process.

30. A method for valuation of an entity holding one or more intellectual property assets, the method comprising:
(a) determining what intellectual property assets are held by the entity;
(b) determining the type of value desired to be computed for the intellectual property assets;
(d) gathering valuation data for the intellectual property assets;
(e) computing a total value of the intellectual property assets held by the entity;
(f) making earnings and price estimates for the entity, or adjusting pre-existing earnings and price estimates for the entity that do not take intellectual property into account, based upon total value computed in step (e); and
(g) making financial recommendations based upon the estimates made in step (f).

31. The method of claim 30 further comprising conducting financial transactions based upon the recommendations in step (g).

32. A financial method comprising gathering data and computing at least one index for indicating performance of a plurality of financial instruments relating to intellectual property assets.

33. The method of claim 32 further comprising using the at least one index as a basis to compare investments, select investments, or a combination thereof.

34. The method of claim 32 further comprising creating a index-mimicking financial instrument that at least approximately tracks market movement of the at least one index.

35. The method of claim 33 further comprising investing in the index-mimicking financial instrument.
